(19) United States
(12) Patent Application Publication
(10) Pub. No.: US 2016/0027593 A1
(43) Pub. Date: Jan. 28, 2016

(54) COMPOSITE ELECTRONIC COMPONENT AND BOARD HAVING THE SAME

(71) Applicant: SAMSUNG ELECTRO-MECHANICS CO., LTD., Suwon-Si (KR)

(72) Inventors: Young Ghyu AHN, Suwon-Si (KR); Sang Soo PARK, Suwon-Si (KR); Byoung Hwa LEE, Suwon-Si (KR); Kyo Kwang LEE, Suwon-Si (KR)

(21) Appl. No.: 14/806,598

(22) Filed: Jul. 22, 2015

(30) Foreign Application Priority Data
Jul. 23, 2014 (KR) 10-2014-0093590
Nov. 6, 2014 (KR) 10-2014-0153909

(51) Int. Cl. H01G 15/00; H01G 4/12; H01G 4/012; H01G 9/00; H01G 9/15; H01G 9/042; H01G 9/012; H01G 4/228; H01G 4/30; H01G 9/025

(52) U.S. Cl. CPC H01G 15/00; H01G 4/30; H01G 4/12; H01G 4/012; H01G 9/025; H01G 9/15; H01G 9/042; H01G 9/012; H01G 4/228; H01G 9/0029

(57) ABSTRACT

A composite electronic component includes an insulation sheet, a tantalum capacitor including a body part containing a sintered tantalum powder and a tantalum wire of which a portion is embedded in the body part, and disposed on the insulation sheet, a multilayer ceramic capacitor including a ceramic body in which a plurality of dielectric layers and internal electrodes are alternately disposed and first and second external electrodes disposed on a lower surface of the ceramic body, and disposed on the insulation sheet, and a molded part enclosing the tantalum capacitor and the multilayer ceramic capacitor, the internal electrodes including a lead-out portion led out to the lower surface of the ceramic body.

### CROSS-REFERENCE TO RELATED APPLICATION

This application claims the priority and benefit of Korean Patent Application Nos. 10-2014-0093590 filed on Jul. 23, 2014 and 10-2014-0153909 filed on Nov. 6, 2014, with the Korean Intellectual Property Office, the disclosures of which are incorporated herein by reference.

### BACKGROUND

The present disclosure relates to a composite electronic component including a plurality of passive elements and a board having the same.

A multilayer ceramic capacitor, a multilayer chip electronic component, may have a structure in which a plurality of dielectric layers and internal electrodes are alternately stacked, the internal electrodes having opposing polarities and being interposed between the dielectric layers.

Since the dielectric layers as described above may have piezoelectric and electrostrictive properties, when a direct current (DC) or alternating current (AC) voltage is applied to a multilayer ceramic capacitor, a piezoelectric phenomenon may occur in the dielectric layers interposed between the internal electrodes, causing vibrations.

Such vibrations maybe transferred to a printed circuit board on which the multilayer ceramic capacitor is mounted through connective solders of the multilayer ceramic capacitor, such that the entire printed circuit board may act as an acoustic radiation surface to generate a vibration sound, commonly known as noise.

The vibration sound may have a frequency corresponding to an audio frequency in a region of 20 to 20,000 Hz causing listener discomfort. The vibration sound causing listener discomfort as described above is known as acoustic noise.

In order to decrease the incidence of acoustic noise, research into a product in which a thickness of a lower cover layer of the multilayer ceramic capacitor is increased has been conducted.

However, research into a product having a greater effect in the reduction of acoustic noise has been further required.

### SUMMARY

An aspect of the present disclosure may provide a composite electronic component having a high degree of effectiveness in decreasing acoustic noise.

An aspect of the present disclosure may also provide a composite electronic component having low equivalent series resistance (ESR)/equivalent series inductance (ESL), improved DC-bias characteristics, and a reduced chip thickness.

According to an aspect of the present disclosure, a composite electronic component may include a composite body in which a multilayer ceramic capacitor and a tantalum capacitor are coupled to each other.

According to another aspect of the present disclosure, there maybe provided a composite electronic component of which, in an impedance vs. input signal frequency graph, an inflection point of impedance is generated in a frequency region lower than a self resonance frequency (SRF).

According to another aspect of the present disclosure, a composite electronic component may include a composite body including a multilayer ceramic capacitor and a tantalum capacitor. Internal electrodes of the multilayer ceramic capacitor may be led out to a lower portion of a ceramic body to decrease a size of a current loop formed in the multilayer ceramic capacitor, such that equivalent series inductance (ESL) of the composite electronic component may be decreased.

According to another aspect of the present disclosure, a board having a composite electronic component may include a printed circuit board on which electrode pads are formed, the composite electronic component as described above, mounted on the printed circuit board, and a solder connecting the electrode pads and the composite electronic component to each other.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating terminal electrodes and a molded part of a composite electronic component according to an exemplary embodiment in the present disclosure;

FIG. 2 is a cross-sectional view taken along line A-A′ of FIG. 1;

FIG. 3A is a cross-sectional view of a multilayer ceramic capacitor taken along line P-P′ of FIG. 2, and FIG. 3B is a cross-sectional view of the multilayer ceramic capacitor taken along line Q-Q′ of FIG. 2;

FIGS. 4A and 4B are cross-sectional views of a multilayer ceramic capacitor illustrating modified examples of first and second internal electrodes of the multilayer ceramic capacitor according to the exemplary embodiment in the present disclosure;

FIG. 5 is a cross-sectional view taken along line B-B′ of FIG. 1;

FIG. 6 is a cross-sectional view of a composite electronic component illustrating a modified example of a connective conductor part according to the exemplary embodiment in the present disclosure;

FIG. 7 is enlarged views of part C1 and part C2 of FIG. 5;

FIGS. 8A and 8B are graphs illustrating equivalent series resistance (ESR) and impedance vs. frequency of composite electronic components according to the exemplary embodiment in the present disclosure and other comparative examples;

FIG. 9 is a graph illustrating output voltage vs. time, according to embodiments of the present disclosure and comparative examples;

FIG. 10 is a graph illustrating voltage ripple (ΔV) vs. ESR depending on a volume ratio of a multilayer ceramic capacitor and a tantalum capacitor in the composite electronic component according to the exemplary embodiment in the present disclosure; and

FIG. 11 is a perspective view illustrating a form in which the composite electronic component of FIG. 1 is mounted on a printed circuit board.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Directions of a hexahedron will be defined in order to allow exemplary embodiments of the present disclosure to be clearly described. L, W and T directions, depicted in the accompanying drawings, refer to a length direction, a width direction, and a thickness direction, respectively.

### Composite Electronic Component

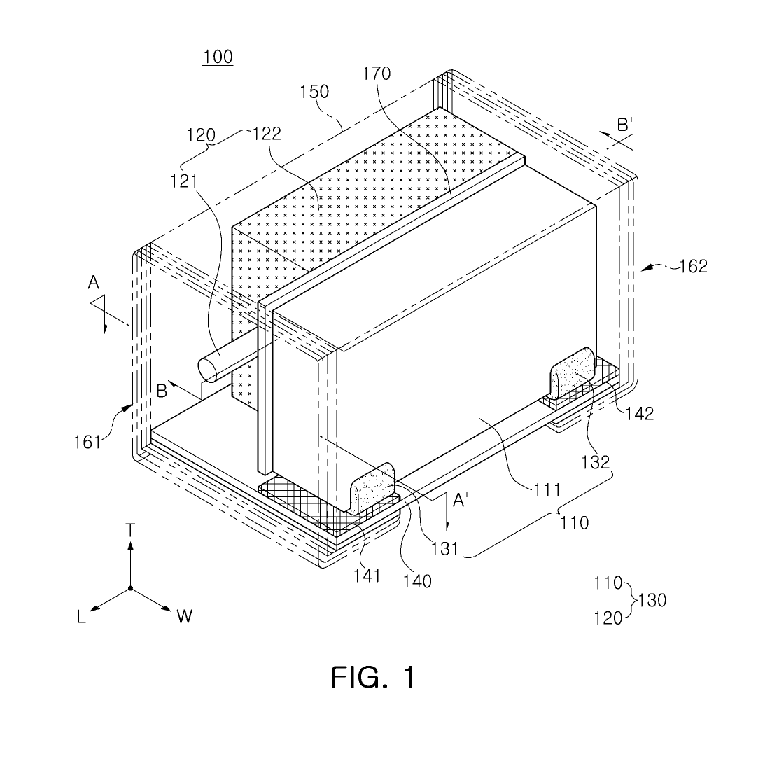

FIG. 1 is a perspective view illustrating terminal electrodes and a molded part of a composite electronic component according to an exemplary embodiment in the present disclosure.

Referring to FIG. 1, a composite electronic component 100 according to an exemplary embodiment in the present disclosure may include an insulation sheet 140, a composite body 130 disposed on the insulation sheet 140 and including a multilayer ceramic capacitor 110 and a tantalum capacitor 120, a molded part 150, and terminal electrodes 161 and 162.

The terminal electrodes (161 and 162) may include an anode terminal 161 and a cathode terminal 162.

According to the exemplary embodiment in the present disclosure, due to a structure of the composite electronic component including the composite body 130 in which the multilayer ceramic capacitor 110 and the tantalum capacitor 120 are coupled to each other, the composite electronic component may have a high degree of effectiveness in decreasing acoustic noise, implementing high capacitance, and may have low equivalent series resistance (ESR)/equivalent series inductance (ESL), improved DC-bias characteristics, and a reduced chip thickness.

The tantalum capacitor may implement high capacitance and have excellent DC-bias characteristics, and may not generate acoustic noise when mounted on a board.

On the contrary, a problem in which the tantalum capacitor has high equivalent series resistance (ESR) may occur.

Meanwhile, the multilayer ceramic capacitor may have relatively low equivalent series resistance (ESR) and equivalent series inductance (ESL), but DC-bias characteristics thereof may be low as compared to those of the tantalum capacitor, and it may be difficult to implement high capacitance.

In addition, at the time of mounting the multilayer ceramic capacitor on a board, acoustic noise may be generated.

However, since the composite electronic component 100 according to the exemplary embodiment in the present disclosure includes the composite body 130 in which the multilayer ceramic capacitor 110 and the tantalum capacitor 120 are coupled to each other, high equivalent series resistance (ESR), a disadvantage of the tantalum capacitor, may be decreased.

Further, deterioration of DC-bias characteristics, a disadvantage of the multilayer ceramic capacitor, may be prevented, and a chip thickness may be reduced.

In addition, according to the exemplary embodiment in the present disclosure, the multilayer ceramic capacitor, which generates acoustic noise at the time of being mounted on a board, and the tantalum capacitor, which does not generate acoustic noise at the time of being mounted on a board, are coupled to each other at a predetermined volume ratio, such that the effect of decreasing acoustic noise may be excellent.

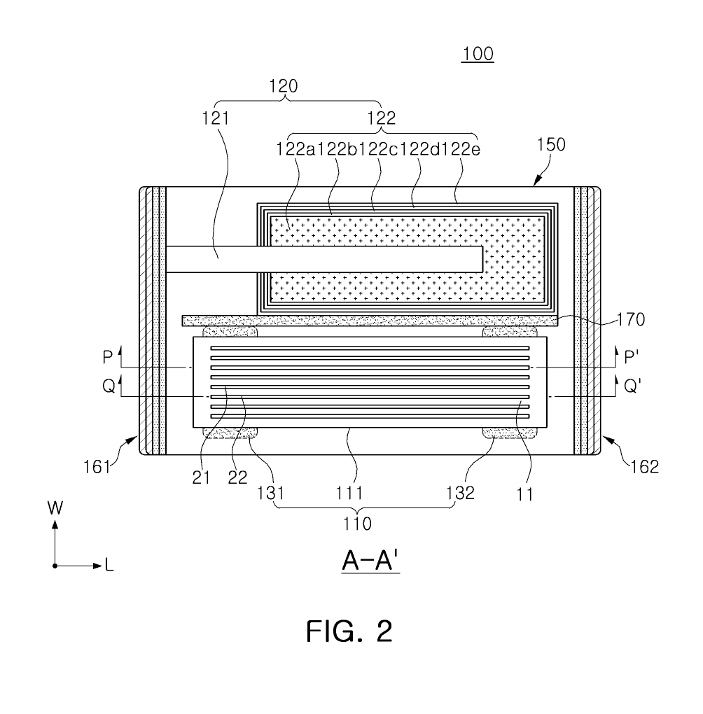

FIG. 2 is a cross-sectional view taken along line A-A′ of FIG. 1.

As illustrated in FIGS. 1 and 2, according to the exemplary embodiment in the present disclosure, the multilayer ceramic capacitor 110 may include a ceramic body 111 in which a plurality of dielectric layers 11 and internal electrodes 21 and 22 disposed with a respective dielectric layer interposed therebetween are stacked, and external electrodes 131 and 132 formed on an outer surface of the ceramic body to be connected to the internal electrodes.

The ceramic body 111 may have a substantially hexahedral shape having upper and lower surfaces opposing each other in the thickness direction, first and second end surfaces opposing each other in the length direction, and third and fourth side surfaces opposing each other in the width direction.

In the exemplary embodiment of the present disclosure, when the multilayer ceramic capacitor is disposed on the insulation sheet, the upper or lower surface of the ceramic body 111 may become a mounting surface adjacent to and facing the insulation sheet 140. Further, after the multilayer ceramic capacitor is disposed on the insulation sheet 140, the mounting surface adjacent to and facing the insulation sheet may become a lower surface, and a surface opposing the lower surface may become an upper surface.

The internal electrode may include first and second internal electrodes 21 and 22, and the first and second internal electrodes 21 and 22 may be alternately disposed on the dielectric layer 11 with a respective dielectric layer 11 interposed therebetween.

The ceramic body 111 may be formed by stacking the plurality of dielectric layers and the internal electrodes and then sintering the stacked dielectric layers and internal electrodes.

The dielectric layer 11 may contain ceramic powder having high permittivity, for example, a barium titanate (BaTiO₃)-based powder or a strontium titanate (SrTiO₃)-based powder, or the like, but the dielectric layer 11 is not limited thereto.

The first and second internal electrodes 21 and 22 may be formed using a conductive paste formed of one or more of, for example, a noble metal such as palladium (Pd), a palladium-silver (Pd—Ag) alloy, or the like, nickel (Ni), and copper (Cu), but the first and second internal electrodes 21 and 22 are not limited thereto.

The external electrodes 131 and 132 may be disposed on the outer surfaces of the ceramic body 111 to thereby be electrically connected to the internal electrodes. The external electrode may include first and second external electrodes 131 and 132. The first external electrode 131 may be electrically connected to the first internal electrode 21, and the second external electrode 132 may be electrically connected to the second internal electrode 22.

According to the exemplary embodiment in the present disclosure, a nickel/tin (Ni/Sn) plating layer may be omitted from the first and second external electrodes 131 and 132, unlike a general multilayer ceramic capacitor.

Since the composite electronic component includes the molded part 150 enclosing the composite body 130 including the multilayer ceramic capacitor 110 and the tantalum capacitor 120 disposed on an upper surface of the insulation sheet 140 as described below, there is no need to form a plating layer on the first and second external electrodes 131 and 132 of the multilayer ceramic capacitor 110.

Therefore, there is no problem such as a deterioration of reliability due to the infiltration of a plating solution into the ceramic body 111 of the multilayer ceramic capacitor 110.

As illustrated in FIG. 2, according to the exemplary embodiment in the present disclosure, the tantalum capacitor 120 may include a body part 122 and a tantalum wire 121. The tantalum wire 121 may be embedded in the body part 122 so that a portion of the tantalum wire 121 in the length direction is exposed to one surface of the body part.

The body part 122 of the tantalum capacitor may include an anode body 122a, a dielectric layer 122b, a solid electrolyte layer 122c, a carbon layer 122d, and a cathode layer 122e, but is not limited thereto.

The anode body 122a may be configured as a porous body containing a sintered tantalum powder.

The dielectric layer 122b may be formed on a surface of the anode body 122a. The dielectric layer 122b may be formed by oxidation of the surface of the anode body. For example, the dielectric layer 122b may be formed of a dielectric material containing tantalum oxide (Ta₂O₅), which is an oxide of tantalum forming the anode body, and may be formed on the surface of the anode body at a predetermined thickness.

The solid electrolyte layer 122c may be formed on a surface of the dielectric layer 122b. The solid electrolyte layer may contain one or more of a conductive polymer or manganese dioxide (MnO₂).

In the case in which the solid electrolyte layer 122c is formed of the conductive polymer, the solid electrolyte layer 122c may be formed on the surface of the dielectric layer by a chemical polymerization method or an electrolytic-polymerization method. A conductive polymer raw material is not particularly limited as long as it has conductivity. For example, the conductive polymer raw material may contain polypyrrole, polythiophene, polyaniline, or the like.

In the case in which the solid electrolyte layer 122c is formed of manganese dioxide (MnO₂), conductive manganese dioxide may be formed on the surface of the dielectric layer by dipping the anode body having the dielectric layer formed on the surface thereof in a aqueous manganese solution such as a manganese nitrate solution, and pyrolyzing the aqueous manganese solution.

The carbon layer 122d containing carbon may be disposed on the solid electrolyte layer 122c.

The carbon layer 122d may be formed of a carbon paste. For example, the carbon layer 122d may be formed by applying the carbon paste dispersed in water or an organic solvent in a state in which a conductive carbon raw material powder such as natural graphite, carbon black, or the like, is mixed with a binder, a dispersant, or the like, to the solid electrolyte layer.

The cathode layer 122e containing a conductive metal may be disposed on the carbon layer 122d to improve electric connectivity with the cathode terminal, and the conductive metal contained in the cathode layer may be silver (Ag).

Although not particularly limited, for example, the tantalum capacitor may be connected to the external terminal in a structure in which an internal lead frame is not provided.

According to the exemplary embodiment in the present disclosure, the multilayer ceramic capacitor 110 and the tantalum capacitor 120 may be connected to each other in parallel.

According to the exemplary embodiment in the present disclosure, as illustrated in FIG. 2, the multilayer ceramic capacitor 110 and the tantalum capacitor 120 may be disposed on the insulation sheet 140.

The insulation sheet 140 is not particularly limited as long as it has insulation properties, and the insulation sheet 140 maybe manufactured using an insulation material such as a ceramic-based material, or the like.

The molded part 150 maybe formed to cover the composite body 130 including the multilayer ceramic capacitor 110 and the tantalum capacitor 120 and the upper surface of the insulation sheet 140 on which the multilayer ceramic capacitor and the tantalum capacitor are disposed.

The molded part 150 may serve to protect the multilayer ceramic capacitor 110 and the tantalum capacitor 120 from external environments, and may be mainly formed of an epoxy or silica-based mold compound (EMC), or the like, but the molded part 150 is not limited thereto.

The composite electronic component according to the exemplary embodiment in the present disclosure may be implemented as a single component in which the multilayer ceramic capacitor 110 and the tantalum capacitor 120 are joined to each other due to the molded part 150.

An insulation layer 170 may be disposed between the multilayer ceramic capacitor 110 and the tantalum capacitor 120, and short-circuits of respective elements disposed in the composite electronic component may be prevented by the insulation layer 170.

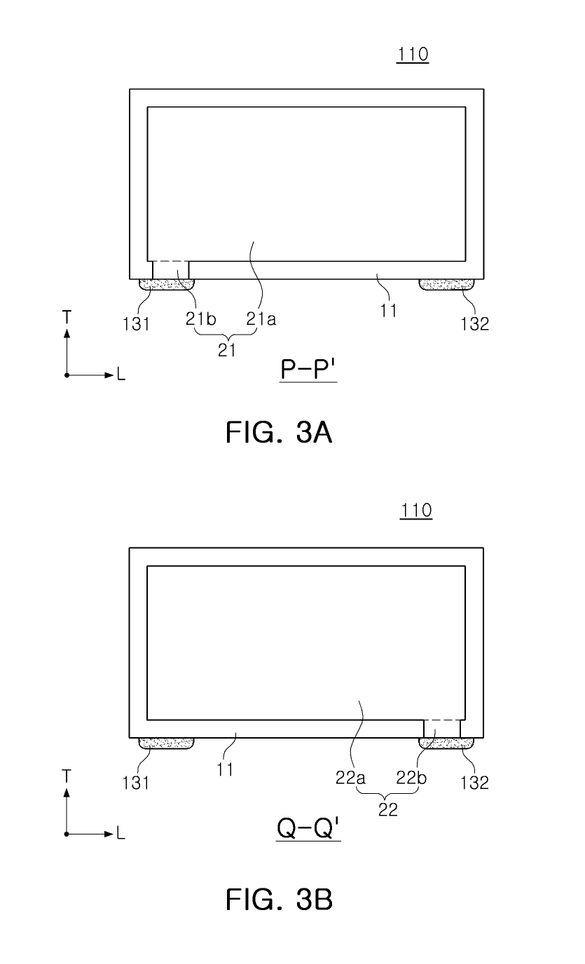

FIG. 3A is a cross-sectional view of the multilayer ceramic capacitor 110 taken along line P-P′ of FIG. 2, and FIG. 3B is a cross-sectional view of the multilayer ceramic capacitor 110 taken along line Q-Q′ of FIG. 2.

As illustrated in FIGS. 3A and 3B, the internal electrode may include first and second internal electrodes 21 and 22, and the first and second internal electrodes 21 and 22 may be alternately disposed on the dielectric layers 11 with a respective dielectric layer 11 interposed therebetween.

According to the exemplary embodiment in the present disclosure, the first internal electrode 21 may include a first main portion 21a overlapping the second internal electrode to form capacitance and a first lead-out portion 21b connected to the first main portion to thereby be led out to the outer surface of the ceramic body, and the second internal electrode 22 may include a second main portion 22a overlapping the first internal electrode to form capacitance and a second lead-out portion 22b connected to the second main portion to thereby be led out to the outer surface of the ceramic body.

The first and second lead-out portions 21b and 22b may be exposed to the same surface of the ceramic body, such that the first and second internal electrodes 21 and 22 may be disposed on that surface of the ceramic body.

In addition, the first and second internal electrodes 21 and 22 may be disposed with respect to the insulation sheet 140.

According to the exemplary embodiment in the present disclosure, the first and second internal electrodes 21 and 22 may be disposed above a board at the time of mounting the composite electronic component on the board.

According to the exemplary embodiment in the present disclosure, the width direction of the ceramic body may be a direction in which the internal electrodes are stacked.

The first and second lead-out portions 21b and 22b may be exposed to the lower surface of the ceramic body, and the lower surface of the ceramic body may be the mounting surface of the ceramic body adjacent to and facing the insulation sheet 140 in the composite electronic component.

The external electrodes (131 and 132) may include the first external electrode 131 connected to the first internal electrode 21 and the second external electrode 132 connected to the second internal electrode 22, and the first and second external electrodes 131 and 132 may be disposed on the same surface of the ceramic body 111.

For example, the first and second lead-out portions 21b and 22b may be exposed to the lower surface of the ceramic body 111, and the first and second external electrodes 131 and 132 may be disposed on the lower surface of the ceramic body to be connected to the first and second lead-out portions 21b and 22b, respectively.

When the lead-out portions of the first and second internal electrodes 21 and 22 are exposed to the lower surface of the ceramic body 111, which is the mounting surface of the ceramic body 111, and the first and second external electrodes 131 and 132 are disposed on the lower surface of the ceramic body as in the exemplary embodiment in the present disclosure, equivalent series inductance (ESL) of the composite electronic component may be decreased.

When the internal electrodes 21 and 22 of the multilayer ceramic capacitor are exposed to the lower surface of the ceramic body 111 and a current is applied to the external electrodes 131 and 132 disposed on the lower surface of the ceramic body as in the exemplary embodiment in the present disclosure, a size of a current loop formed in the multilayer ceramic capacitor may be decreased, such that equivalent series inductance (ESL) of the multilayer ceramic capacitor may be decreased, and thus, equivalent series inductance (ESL) of the composite electronic component may be decreased.

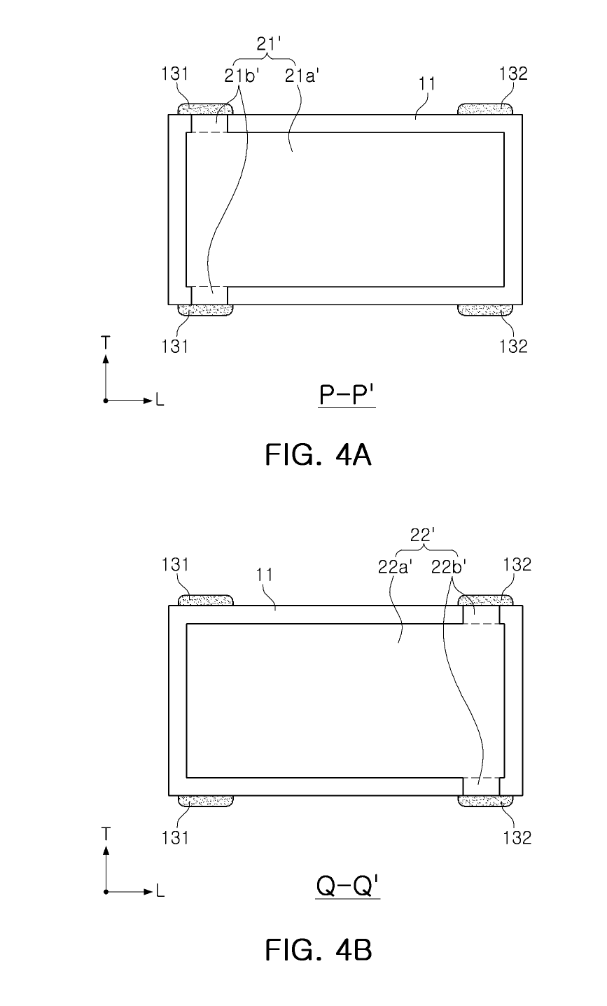

FIGS. 4A and 4B are cross-sectional views of a multilayer ceramic capacitor illustrating modified examples of first and second internal electrodes of the multilayer ceramic capacitor according to the exemplary embodiment in the present disclosure.

Referring to FIGS. 4A and 4B, first and second internal electrodes 21′ and 22′ of the multilayer ceramic capacitor according to the present modified example may include first and second main portions 21a′ and 22a′ and first and second lead-out portions 21b′ and 22b′, respectively. Here, the first and second lead-out portions 21b′ and 22b′ may be led out to the upper and lower surfaces of the ceramic body 111.

For example, the first lead-out portion 21b′ of the multilayer ceramic capacitor may include a first upper lead-out portion led out to the upper surface of the ceramic body and a first lower lead-out portion led out to the lower surface thereof, and the second lead-out portion 22b′ may include a second upper lead-out portion led out to the upper surface of the ceramic body and a second lower lead-out portion led out to the lower surface thereof.

According to the present modified example, first external electrodes 131 may be disposed on the upper and lower surfaces of the ceramic body to be connected to the first lead-out portions 21b′, and second external electrodes 132 may be disposed on the upper and lower surfaces of the ceramic body 111 to be connected to the second lead-out portions 22b′.

According to the present modified example, equivalent series inductance (ESL) of the multilayer ceramic capacitor may be decreased, such that equivalent series inductance (ESL) of the composite electronic component may be decreased.

Further, the multilayer ceramic capacitor may be disposed on the insulation sheet without distinguishing between the upper and lower surfaces of the multilayer ceramic capacitor, such that convenience in manufacturing the composite electronic component may be improved.

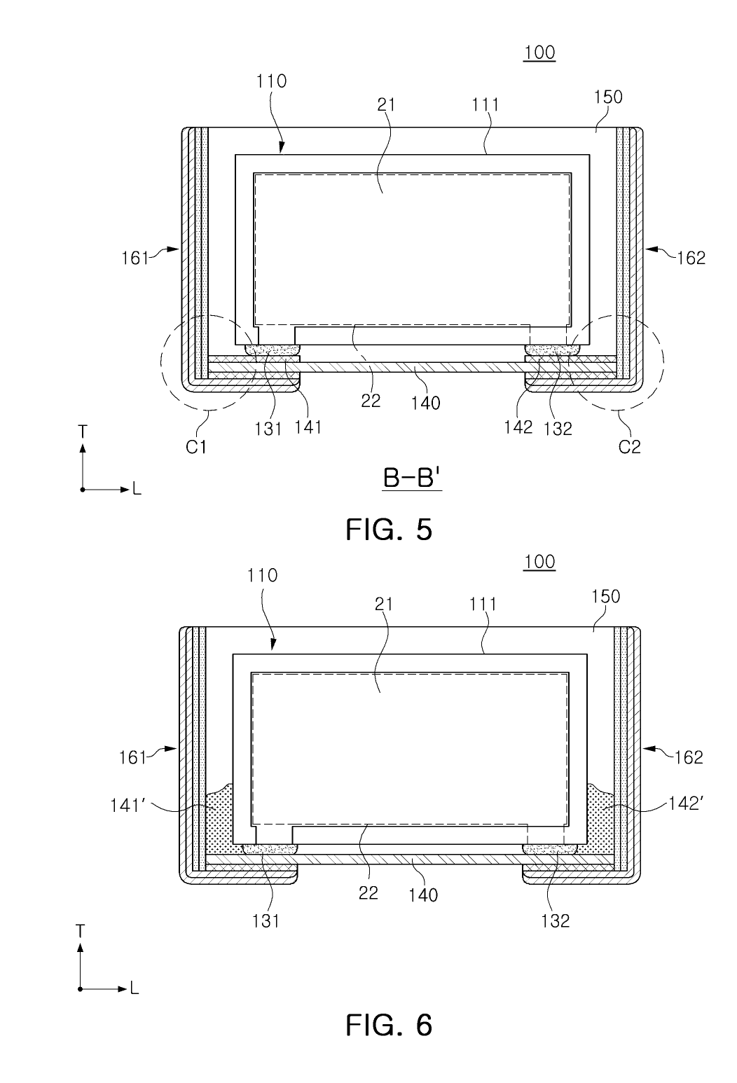

FIG. 5 is a cross-sectional view taken along line B-B′ of FIG. 1.

As illustrated in FIGS. 1 and 5, according to the exemplary embodiment in the present disclosure, the composite electronic component 100 may include the anode and cathode terminals 161 and 162 electrically connected to the multilayer ceramic capacitor 110 and the tantalum capacitor 120.

According to the exemplary embodiment in the present disclosure, the tantalum wire 121 and the first external electrode 131 of the multilayer ceramic capacitor may be connected to the anode terminal 161, and the body part 122 of the tantalum capacitor and the second external electrode 132 of the multilayer ceramic capacitor may be connected to the cathode terminal 162.

The tantalum wire 121 may be exposed to a first end surface of the molded part 150 in the length direction to thereby be connected to the anode terminal 161.

The tantalum capacitor 120 is a tantalum capacitor having a structure in which there is no internal lead frame, and since the tantalum wire 121 may be exposed to the first end surface of the molded part 150 in the length direction, a significantly increased amount of capacitance may be implemented as compared to a structure according to the related art.

As illustrated in FIG. 5, connective conductor parts 141 and 142 may be disposed on at least the upper surface of the insulation sheet 140.

The connective conductor parts 141 and 142 may contain a conductive material, and a shape thereof is not particularly limited as long as the connective conductor parts 141 and 142 may electrically connect the anode and cathode terminals 161 and 162 on outer portions of the molded part and the composite body 130 in the molded part to each other as described below.

According to the exemplary embodiment in the present disclosure, the anode terminal 161 maybe connected to the first external electrode 131 by the first connective conductor part 141, and the cathode terminal 162 may be connected to both the body part 122 of the tantalum capacitor and the second external electrode 132 through the second connective conductor part 142.

The second connective conductor part 142 may be formed as a single element to connect the body part 122 of the tantalum capacitor, the external electrode 132, and the cathode terminal 162 together. Alternatively, the second connective conductor part 142 may be formed as two or more elements to connect the body part 122 of the tantalum capacitor and the cathode terminal 162 to each other and connect the second external electrode 132 and the cathode terminal 162 to each other.

As illustrated in FIG. 5, the connective conductor parts 141 and 142 may have a metal pad shape, for example, be provided as metal pads 141 and 142, but the connective conductor parts 141 and 142 are not limited thereto.

In addition, the metal pads 141 and 142 may contain copper (Cu) but are not limited thereto.

The metal pads may include a first metal pad 141 connected to the first external electrode 131 to thereby be exposed to one end surface of the molded part 150 and a second metal pad 142 connected to the body part 122 of the tantalum capacitor and the second external electrode 132 to thereby be exposed to the other end surface of the molded part 150.

FIG. 6 is a cross-sectional view of a composite electronic component illustrating a modified example of the connective conductor part according to the exemplary embodiment in the present disclosure.

As illustrated in FIG. 6, connective conductor parts 141′ and 142′ may be provided as conductive resin parts formed by curing a conductive resin paste.

The connective conductor parts 141′ and 142′ when provided as conductive resin parts 141′ and 142′ may contain, for example, conductive particles and a base resin.

The conductive particles may be silver (Ag) particles but are not limited thereto, and the base resin may be a thermosetting resin, for example, an epoxy resin.

In addition, the conductive resin parts 141′ and 142′ may contain copper (Cu) as a conductive metal but are not limited thereto.

Further, although not illustrated, the connective conductor parts according to the exemplary embodiment in the present disclosure may include both of the metal pad and the conductive resin part as described above.

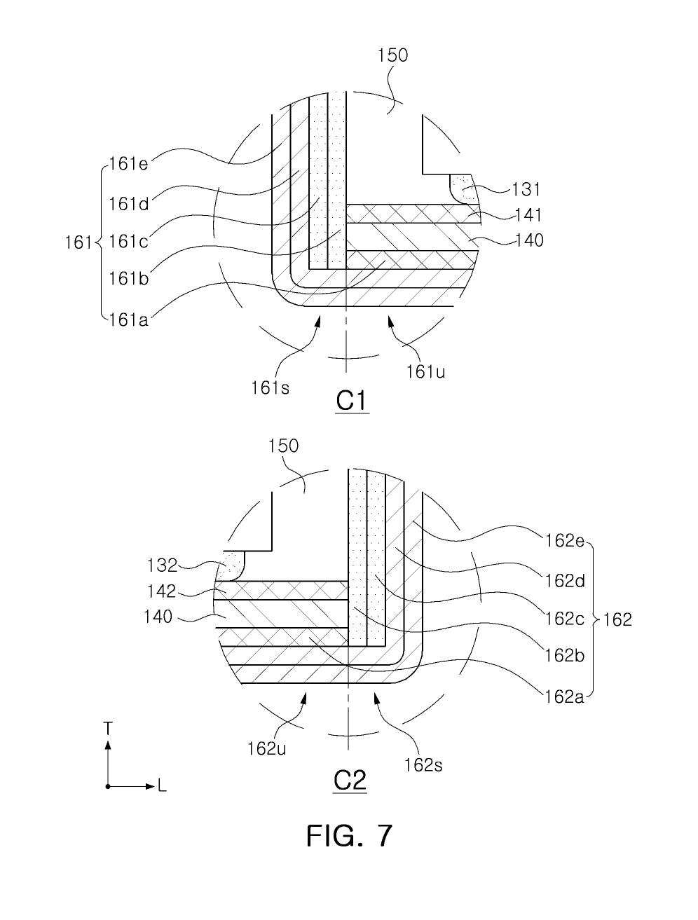

FIG. 7 is enlarged views of parts C1 and C2 of FIG. 5.

Referring to FIGS. 1, 5, and 7, the terminal electrodes may include the anode terminal 161 and the cathode terminal 162.

The anode terminal 161 may be disposed on the first end surface of the molded part 150 in the length direction and a lower surface of the insulation sheet 140 and electrically connected to the tantalum wire 121 and the first external electrode 131.

The cathode terminal 162 maybe disposed on a second end surface of the molded part 150 in the length direction and the lower surface of the insulation sheet 140 and electrically connected to the body part 122 of the tantalum capacitor and the second external electrode 132.

The anode terminal 161 and the first external electrode 131 may be connected to each other by the connective conductor part 141, and the cathode terminal 162 and the body part 122 of the tantalum capacitor maybe connected to each other by the connective conductor part 142, distinguished from the connective conductor part 141.

According to the exemplary embodiment in the present disclosure, the anode terminal 161 may be extended in the length direction to cover a portion of the lower surface of the insulation sheet 140, the cathode terminal 162 may be extended in the length direction to cover a portion of the lower surface of the insulation sheet 140, and the anode terminal 161 and the cathode terminal 162 may be spaced apart from each other on the lower surface of the insulation sheet 140.

The anode terminal 161 may include an anode side terminal part 161s disposed on the end surface of the molded part 150 and an anode lower terminal part 161u disposed on the lower surface of the insulation sheet 140, and the cathode terminal 162 may include a cathode side terminal part 162s disposed on the end surface of the molded part 150 and a cathode lower terminal part 162u disposed on the lower surface of the insulation sheet 140.

According to the exemplary embodiment in the present disclosure, the anode terminal 161 may include a lower base layer 161a, side base layers 161b and 161c connected to the lower base layer 161a, and plating layers 161d and 161e enclosing the lower base layer 161a and the side base layers 161b and 161c.

Further, the cathode terminal 162 may include a lower base layer 162a, side base layers 162b and 162c connected to the lower base layer 162a, and plating layers 162d and 162e enclosing the lower base layer 162a and the side base layers 162b and 162c.

Although the lower base layers 161a and 162a are illustrated as single layers, respectively, and the side base layers 161b and 161c, and 162b and 162c are illustrated as two layers, respectively, in FIG. 7, the lower base layers and the side base layers are not limited thereto but may be disposed in various manners.

The anode and cathode terminals 161 and 162 may be formed by a process of dry-sputtering or plating at least one of Cr, Ti, Cu, Ni, Pd, and Au, or forming and etching a metal layer of at least one of Cr, Ti, Cu, Ni, Pd, and Au, but are not limited thereto.

In addition, the anode and cathode terminals 161 and 162 maybe formed by a method of forming the lower base layers 161a and 162a and then forming the side base layers 161b, 161c, 162b, and 162c to be connected to the lower base layers 161a and 162a, respectively.

The lower base layers 161a and 162a may be formed by etching but are not limited thereto.

The lower base layers 161a and 162a may be disposed on the lower surface of the insulation sheet 140, and a pattern may be formed by performing an etching process for forming the lower base layers 161a and 162a after applying a metal thin film to the lower surface of the insulation sheet 140.

The lower base layers 161a and 162a may contain, for example, copper (Cu), but are not limited thereto.

For example, when the lower base layers 161a and 162a are formed using copper (Cu), connection thereof with the side base layers 161b, 161c, 162b, and 162c formed by a separate process may be excellent, and electric conductivity thereof may also be excellent.

Meanwhile, the side base layers 161b, 161c, 162b, and 162c may be formed by deposition, for example, a sputtering method.

The side base layers 161b, 161c, 162b, and 162c may be composed of two layers (inner layers and outer layers), but are not limited thereto.

Among the side base layers 161b, 161c, 162b, and 162c, inner side base layers 161b and 162b may contain one or more of Cr or Ti to thereby be formed by a sputtering method, and be connected to the lower base layers 161a and 162a.

Among the side base layers 161b, 161c, 162b, and 162c, outer side base layers 161c and 162c may contain Cu and be formed by a sputtering method.

According to the exemplary embodiment in the present disclosure, the tantalum capacitor and the multilayer ceramic capacitor may be connected to each other in parallel on the insulation sheet 140 used to form anode and cathode terminals of a frame-less tantalum capacitor in which there is no internal lead frame.

According to the exemplary embodiment in the present disclosure, a composite electronic component in which impedance of a tantalum capacitor is exhibited in a relatively low frequency section and impedance of a multilayer ceramic capacitor is exhibited in a relatively high frequency section may be provided.

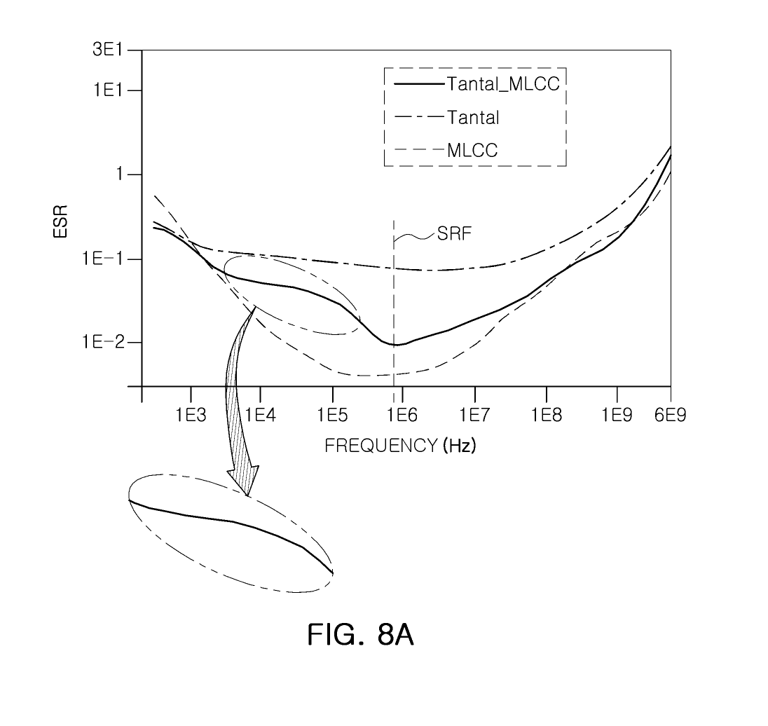

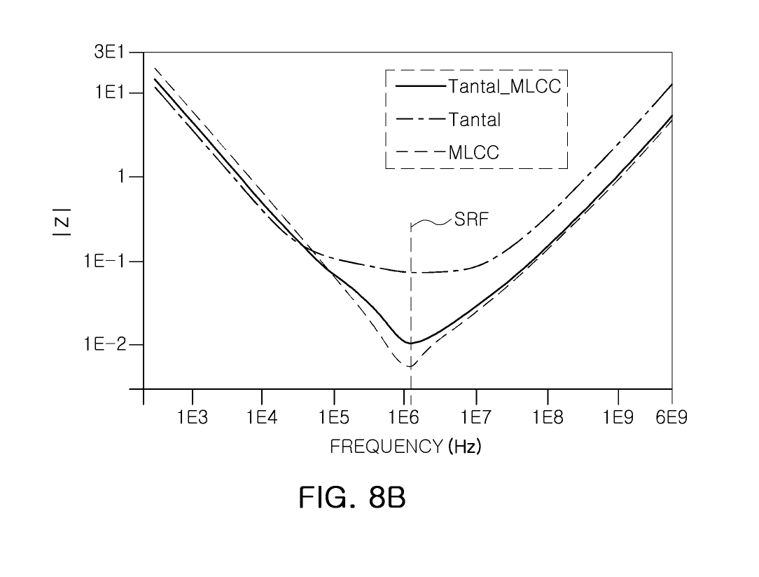

FIGS. 8A and 8B are graphs indicating equivalent series resistance (ESR) and impedance (Z), respectively, vs. frequency of the composite electronic components (the Tantal_MLCC line) according to the exemplary embodiment in the present disclosure and other comparative examples.

Referring to FIGS. 8A and 8B, in the case of the composite electronic component according to the exemplary embodiment in the present disclosure, inflection points of equivalent series resistance (ESR) and impedance are generated in at least one of frequency regions lower or higher than a self-resonant frequency (SRF).

For example, according to the exemplary embodiment in the present disclosure, in the impedance vs. frequency graph, impedance of the tantalum capacitor (the Tantal line) is exhibited in a low frequency region, and impedance of the multilayer ceramic capacitor (the MLCC line) is exhibited in a high frequency region.

Therefore, in the equivalent series resistance (ESR) and impedance vs. input signal frequency graphs, the inflection points of the equivalent series resistance (ESR) and impedance are generated in at least one of the frequency regions lower or higher than the self-resonant frequency (SRF).

The inflection point of the equivalent series resistance (ESR) and impedance may be generated in at least one of the frequency regions lower or higher than the self-resonant frequency (SRF) or may be generated in both of the frequency regions lower and higher than the self-resonant frequency (SRF).

Since the inflection point of the equivalent series resistance (ESR) and impedance is generated in at least one of the frequency regions lower or higher than the self-resonant frequency (SRF), in the composite electronic component according to the exemplary embodiment in the present disclosure, relatively low equivalent series resistance may be implemented.

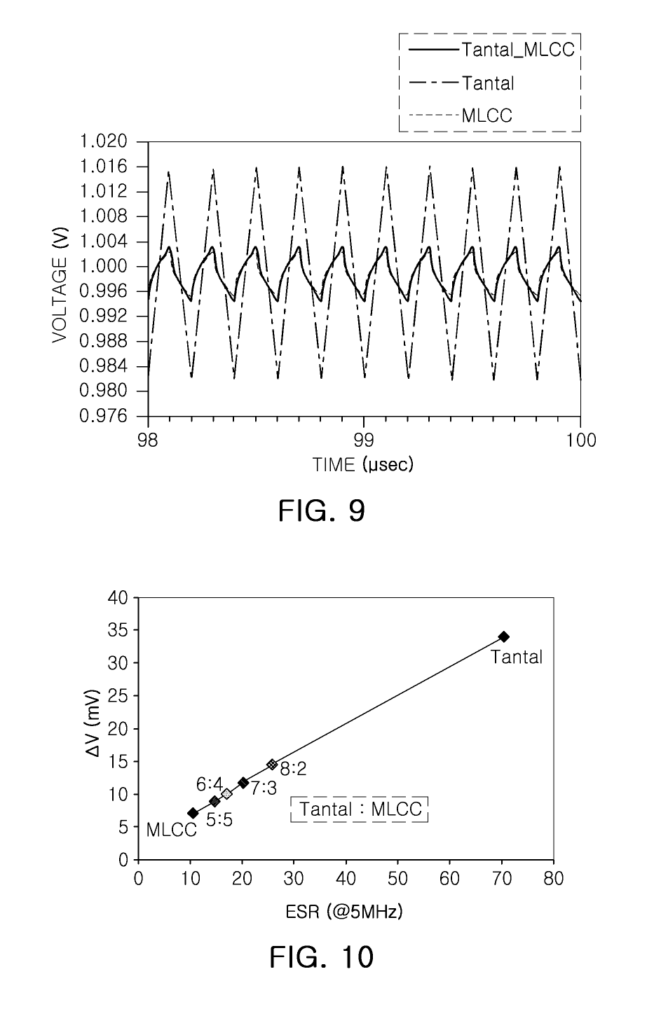

FIG. 9 is a graph illustrating output voltage vs. time, according to embodiments of the present disclosure and comparative examples.

Referring to FIG. 9, it may be appreciated that in the case of embodiments of the present disclosure, voltage ripple is significantly decreased as compared to comparative examples using only a tantalum capacitor (the Tantal line), and the voltage ripple is almost similar to that in comparative examples using only a multilayer ceramic capacitor (the MLCC line).

It may be appreciated that in the case of comparative examples using only the tantalum capacitor, the voltage ripple was 34 mV, but in the case of embodiments of the present disclosure, the voltage ripple was decreased to 9 mV similar to the voltage ripple (7 mV) in comparative examples using only the multilayer ceramic capacitor.

The following Table 1 indicates capacitance, equivalent series resistance (ESR), equivalent series inductance (ESL), and acoustic noise characteristics depending on a volume ratio of a tantalum capacitor and a multilayer ceramic capacitor (a volume of the tantalum capacitor: a volume of the multilayer ceramic capacitor) in the composite electronic component according to the exemplary embodiment in the present disclosure.

TABLE 1

| | Volume Ratio | | | | |
|---|---|---|---|---|---|
| | of Tantalum | | | | |
| | Capacitor and | | | | |
| | Multilayer | | | | Acoustic |
| | Ceramic Capacitor | Capacitance | ESR | ESL | Noise |
| Sample | (T:M) | (μF) | (mΩ) | (pH) | (dBA) |
| 1* | 10:0 | 45.0 | 150 | 471 | 16.6 |
| 2* | 9.5:0.5 | 44.9 | 58 | 415 | 16.6 |
| 3 | 9:1 | 44.7 | 27 | 369 | 16.7 |
| 4 | 8:2 | 44.4 | 22 | 313 | 16.7 |
| 5 | 7:3 | 44.1 | 17 | 281 | 16.8 |
| 6 | 6:4 | 43.8 | 13 | 258 | 16.9 |
| 7 | 5:5 | 43.5 | 11 | 240 | 16.9 |
| 8 | 4:6 | 43.2 | 9.2 | 225 | 17.3 |
| 9 | 3:7 | 42.9 | 8.3 | 213 | 17.5 |
| 10 | 2:8 | 42.6 | 7.3 | 203 | 18.1 |
| 11* | 1:9 | 42.3 | 6.2 | 197 | 26.5 |
| 12* | 0:10 | 42.0 | 5.1 | 207 | 28.2 |

*Comparative examples

Referring to Table 1, it may be appreciated that in samples 1 and 2 corresponding to cases in which the volume ratio of the tantalum capacitor and the multilayer ceramic capacitor coupled to each other in the composite electronic component was more than 9:1, equivalent series resistance (ESR) was increased.

In the case of a capacitor used in a power supply terminal, when an equivalent series resistance (ESR) value is more than 30 mΩ, voltage ripple and radiation noise may be increased, and power efficiency may be deteriorated.

It may be confirmed that in samples 11 and 12 corresponding to the cases in which the volume ratio of the tantalum capacitor and the multilayer ceramic capacitor coupled to each other in the composite electronic component was less than 2:8, an effect of decreasing acoustic noise was not large.

In samples 3 to 10 of Embodiments of the present disclosure, corresponding to the cases in which the volume ratio of the tantalum capacitor and the multilayer ceramic capacitor coupled to each other was 9:1 to 2:8 (tantalum capacitor:multilayer ceramic capacitor), composite electronic components having a relatively low equivalent series resistance (ESR) value and a relatively high degree of effectiveness in decreasing acoustic noise may be implemented.

FIG. 10 is a graph illustrating voltage ripple (ΔV) vs. ESR depending on a volume ratio of a multilayer ceramic capacitor and a tantalum capacitor in the composite electronic component according to the exemplary embodiment in the present disclosure.

Referring to FIG. 10, it may be appreciated that although not particularly limited, when the volume ratio of the tantalum capacitor and the multilayer ceramic capacitor coupled to each other in the composite electronic component according to the exemplary embodiment in the present disclosure was 5:5 to 7:3, an electronic component having low equivalent series resistance (ESR) and voltage ripple (ΔV) values and high capacitance may be implemented.

### Board Having Composite Electronic Component

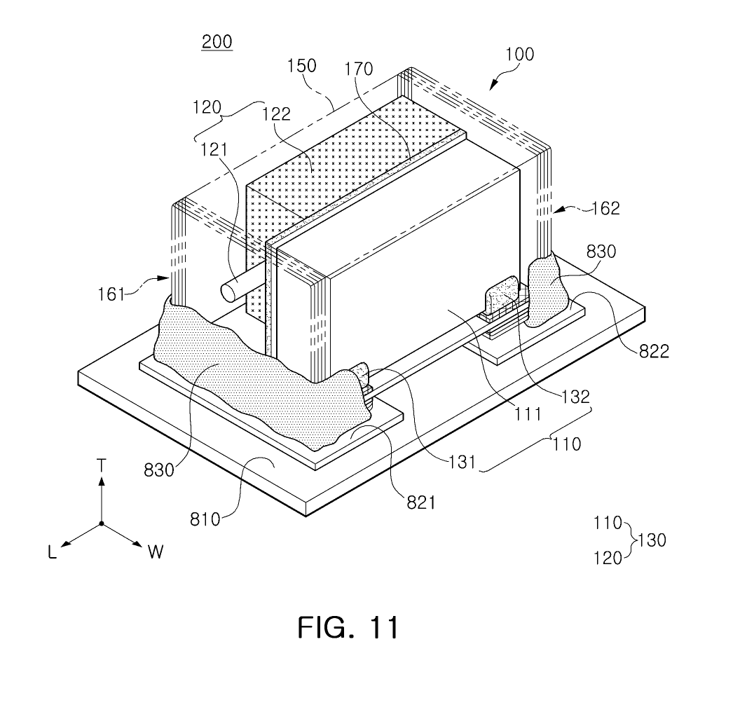

FIG. 11 is a perspective view illustrating a form in which the composite electronic component of FIG. 1 is mounted on a printed circuit board.

Referring to FIG. 11, a board 200 having a composite electronic component according to another exemplary embodiment in the present disclosure may include a printed circuit board 810 having electrode pads 821 and 822 formed thereon, the composite electronic component 100 mounted on the printed circuit board 810, and solders 830 connecting the electrode pads 821 and 822 to the composite electronic component 100.

The board 200 having a composite electronic component according to the exemplary embodiment in the present disclosure may include the printed circuit board 810 on which the composite electronic component 100 is mounted and two or more electrode pads 821 and 822 formed on an upper surface of the printed circuit board 810.

The electrode pads (821 and 822) may include first and second electrode pads 821 and 822 connected to the anode and cathode terminals 161 and 162 of the composite electronic component, respectively.

In this case, the anode and cathode terminals 161 and 162 of the composite electronic component may be electrically connected to the printed circuit board 810 by the solder 830 in a state in which the anode and cathode terminals 161 and 162 are positioned on the first and second electrode pads 821 and 822, respectively, to contact each other.

As set forth above, according to exemplary embodiments of the present disclosure, a composite electronic component having a high degree of effectiveness in decreasing acoustic noise may be provided.

In addition, a composite electronic component capable of implementing high capacitance and having low equivalent series resistance (ESR)/equivalent series inductance (ESL), improved DC-bias characteristics, and a reduced chip thickness may be provided.

While exemplary embodiments have been shown and described above, it will be apparent to those skilled in the art that modifications and variations could be made without departing from the scope of the present invention as defined by the appended claims.

What is claimed is:

1. A composite electronic component comprising:
an insulation sheet;
first and second connective conductor parts disposed on the upper surface of the insulation sheet and respectively extending to first and second ends of the insulation sheet in a length direction;
a tantalum capacitor body part at least partially disposed on the second connective conductor part;
a ceramic body in which first and second internal electrodes are stacked with dielectric layers interposed therebetween, wherein the first and second internal electrodes include respective lead-out portions exposed to the lower surface of the ceramic body;
first and second external electrodes respectively connected to the lead-out portions of the first and second internal electrodes exposed to the lower surface of the ceramic body and respectively disposed on the first and second connective conductor parts;
a molded part above the insulation sheet and enclosing at least the tantalum capacitor body and the ceramic body;
first and second terminal electrodes respectively on first and second end surfaces of the molded part in the length direction and respectively connected to the first and second connective conductor parts.

2. The composite electronic component of claim 1, further comprising a tantalum capacitor wire at least partially embedded in the tantalum capacitor body part and connected to the first terminal electrode.

3. The composite electronic component of claim 1, wherein the second connective conductor part comprises two or more connective conductor parts spaced apart from each other.

4. The composite electronic component of claim 1, wherein the first and second internal electrodes further include respective lead-out portions exposed to the upper surface of the ceramic body.

5. The composite electronic component of claim 4, further comprising first and second external electrodes respectively connected to the lead-out portions of the first and second internal electrodes exposed to the upper surface of the ceramic body.

6. The composite electronic component of claim 1, wherein the first and second terminal electrodes are extending in the length direction to be partially below the insulation sheet.

7. The composite electronic component of claim 6, wherein the first and second terminal electrodes each respectively include a lower base layer, a side base layer connected to the lower base layer, and a plating layer enclosing the lower base layer and the side base layer.

8. The composite electronic component of claim 1, further comprising an insulation layer disposed between the tantalum capacitor body and the ceramic body.

9. The composite electronic component of claim 1, wherein a ratio of the volume of the tantalum capacitor body and tantalum capacitor wire to the volume of the ceramic body and first and second external electrodes is in the range 2:8 to 9:1.

10. The composite electronic component of claim 1, wherein inflection points of equivalent series resistance and inflection points of impedance are generated in at least one of frequency regions lower or higher than a self-resonant frequency.

11. A composite electronic component comprising:
first and second connective conductor parts spaced apart from each other;
a molded part above the first and second connective conductor parts;
first and second terminal electrodes respectively on first and second end surfaces of the molded part in the length direction;
a tantalum capacitor connected to the first terminal electrode, partially disposed on the second connective conductor part, and covered by the molded part; and
a multilayer ceramic capacitor partially disposed on the first connective conductor part, partially disposed on the second connective conductor part, and covered by the molded part.

12. A board having a composite electronic component comprising:
a board;
first and second electrode pads disposed on the upper surface of the board and spaced apart from each other;
the composite electronic component of claim 11;
first and second solders respectively connecting the first and second terminal electrodes of the composite electronic component to the first and second electrode pads.

13. The board having a composite electronic component of claim 11, wherein the tantalum capacitor comprises:
a tantalum capacitor body part at least partially disposed on the second connective conductor part; and
a tantalum capacitor wire at least partially embedded in the tantalum capacitor body part and connected to the first terminal electrode.

14. The board having a composite electronic component of claim 11, wherein the multilayer ceramic capacitor comprises:
a ceramic body in which first and second internal electrodes are stacked with dielectric layers interposed therebetween, wherein the first and second internal electrodes include respective lead-out portions exposed to the lower surface of the ceramic body; and
first and second external electrodes respectively connected to the lead-out portions of the first and second internal electrodes exposed to the lower surface of the ceramic body and respectively disposed on the first and second connective conductor parts.

15. The composite electronic component of claim 11, further comprising an insulation layer disposed between the tantalum capacitor and the multilayer ceramic capacitor.

16. The composite electronic component of claim 11, wherein a ratio of the volume of the tantalum capacitor to the volume of the multilayer ceramic capacitor is in the range 2:8 to 9:1.

17. The composite electronic component of claim 11, wherein inflection points of equivalent series resistance and inflection points of impedance are generated in at least one of frequency regions lower or higher than a self-resonant frequency.

18. A method for manufacturing a composite electronic component, comprising:
forming first and second connective conductor parts on the upper surface of an insulation sheet to be respectively extending to first and second ends of the insulation sheet in a length direction;
disposing a tantalum capacitor such that a body part of the tantalum capacitor is at least partially disposed on the second connective conductor part and such that a tantalum wire of the tantalum capacitor extends to above the first end of the insulation sheet in the length direction;
disposing a multilayer ceramic capacitor such that first and second external electrodes of the multilayer ceramic capacitor are respectively disposed on the first and second connective conductor parts;
forming a molded part above the insulation sheet to cover the tantalum capacitor, other than the first end surface of the tantalum wire, and to cover the multilayer ceramic capacitor;
forming a first terminal electrode on a first end surface of the molded part in the length direction and connected to both the first connective conductor part and the first end surface of tantalum capacitor wire; and
forming a second terminal electrode on a second end surface of the molded part in the length direction and connected to the second connective conductor part.

19. The method for manufacturing a composite electronic component of claim 18, further comprising:
forming first and second electrode pads on the upper surface of a board and spaced apart from each other;
forming first and second solders respectively connecting the first and second terminal electrodes to the first and second electrode pads.

20. The method for manufacturing a composite electronic component of claim 18, wherein the first and second connective conductor parts are conductive resin parts formed by curing a conductive resin paste.

21. The method for manufacturing a composite electronic component of claim 18, wherein:
the multilayer ceramic capacitor includes:
first and second internal electrodes with respective lead-out portions exposed to both the upper and lower surfaces of a ceramic body of the multilayer ceramic capacitor,
first and second external electrodes respectively connected to the lead-out portions of the first and second internal electrodes exposed to the lower surface of the ceramic body, and
first and second external electrodes respectively connected to the lead-out portions of the first and second internal electrodes exposed to the upper surface of the ceramic body;
and wherein the step of disposing a multilayer ceramic capacitor is carried out without distinguishing between the upper and lower surfaces of the multilayer ceramic capacitor,
whereby the convenience in manufacturing the composite electronic component is improved.
